(19) United States
(12) Patent Application Publication
(10) Pub. No.: US 2003/0216909 A1
(43) Pub. Date: Nov. 20, 2003

(54) Voice activity detection

(76) Inventors: Wallace K. Davis, Cambridge, MA (US); Veton K. Kepuska, Newton, MA (US); Harinath K. Reddy, Norwood, MA (US)

Correspondence Address: FISH & RICHARDSON PC, 225 FRANKLIN ST, BOSTON, MA, 02110, US

(21) Appl. No.: 10/144,248

(22) Filed: May 14, 2002

(51) Int. Cl. G10L 11/06

(52) U.S. Cl. 704/210

(57) ABSTRACT

A subset of values is used to discriminate voice activity in a signal. The subset of values belongs to a larger set of values representing a segment of a signal, the larger set of values being suitable for speech recognition.

### BACKGROUND

This description relates to voice activity detection (VAD).

VAD is used in telecommunications, for example, in telephony to detect touch tones and the presence or absence of speech. Detection of speaker activity can be useful in responding to barge-in (when a speaker interrupts a speech, e.g., a canned message, on a phone line), for pointing to the end of an utterance (end-pointing) in automated speech recognition, and for recognizing a word (e.g., an “on” word) intended to trigger start of a service, application, event, or anything else that may be deemed useful.

VAD is typically based on the amount of energy in the signal (a signal having more than a threshold level of energy is assumed to contain speech, for example) and in some cases also on the rate of zero crossings, which gives a crude estimate of its spectral content. If the signal has high-frequency components then zero-crossing rate will be high and vice versa. Typically vowels have low-frequency content compared to consonants.

### SUMMARY

In general, in one aspect, the invention features a method that includes using a subset of values to discriminate voice activity in a signal, the subset of values belonging to a larger set of values representing a segment of speech, the larger set of values being suitable for speech recognition.

Implementations may include one or more of the following features. The values comprise cepstral coefficients. The coefficients conform to an ETSI standard. The subset consists of three values. The cepstral coefficients used to determine presence or absence of voice activity consist of coefficients C2, C4, and C6. Discrimination of voice activity in the signal includes discriminating the presence of speech from the absence of speech. The method is applied to a sequence of segments of the signal. The subset of values satisfies an optimality function that is capable of discriminating speech segments from non-speech segments. The optimality function comprises a sum of absolute values of the values used to discriminate voice activity. A measure of energy of the signal is also used to discriminate voice activity in the signal. Discrimination of voice activity includes comparing an energy level of the signal with a pre-specified threshold. Discrimination of voice activity includes comparing a measure of cepstral based features with a pre-specified threshold. The discriminating for the segment is also based on values associated with other segments of the signal. A voice activity is triggered in response to the discrimination of voice activity in the signal.

In general, in another aspect, the invention features receiving a signal, deriving information about a subset of cepstral coefficients from the signal, and determining the presence or absence of speech in the signal based on the information about cepstral coefficients.

Implementations may include one or more of the following features. The determining of the presence or absence of speech is also based on an energy level of the signal. The determining of the presence or absence of speech is based on information about the cepstral coefficients derived from two or more successive segments of the signal.

In general, in another aspect, the invention features apparatus that includes a port configured to receive values representing a segment of a signal, and logic configured to use the values to discriminate voice activity in a signal, the values comprising a subset of a larger set of values representing the segment of a signal, the larger set of values being suitable for speech recognition.

Implementations may include one or more of the following features. A port is configured to deliver as an output an indication of the presence or absence of speech in the signal. The logic is configured to tentatively determine, for each of a stream of segments of the signal, whether the presence or absence of speech has changed from its previous state, and to make a final determination whether the state has changed based on tentative determinations for more than one of the segments.

Among the advantages of the implementations are one or more of the following. The VAD is accurate, can be implemented for real time use with minimal latency, uses a small amount of CPU and memory, and is simple. Decisions about the presence of speech are not unduly influenced by short-term speech events.

Other advantages and features will become apparent from the following description and from the claims.

### DESCRIPTION

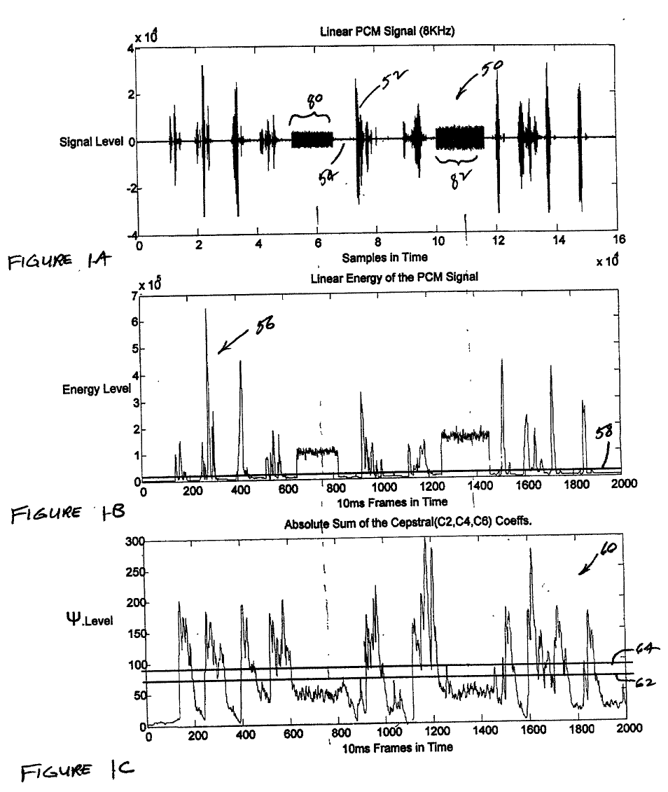

FIGS. 1A, 1B, and 1C show plots of experimental results.

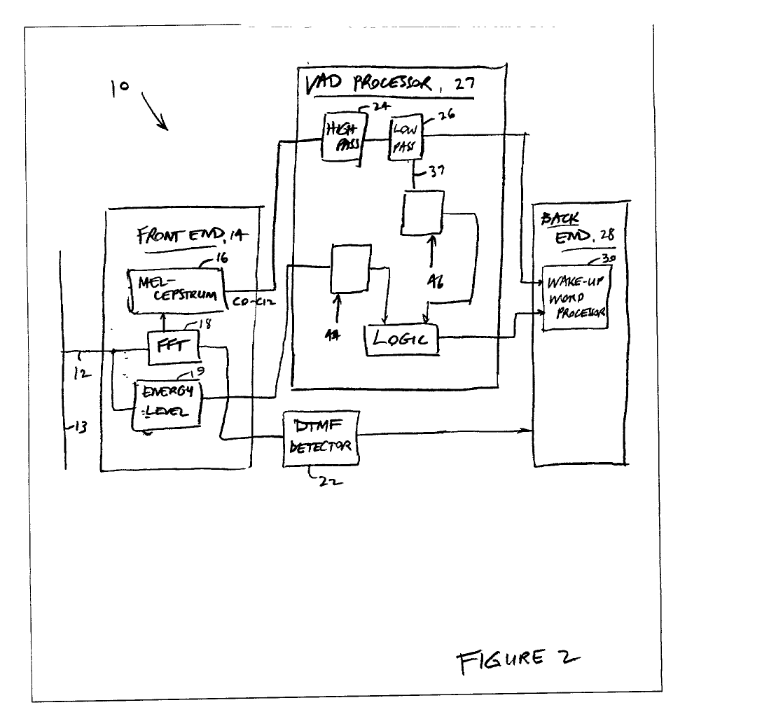

FIG. 2 is a block diagram.

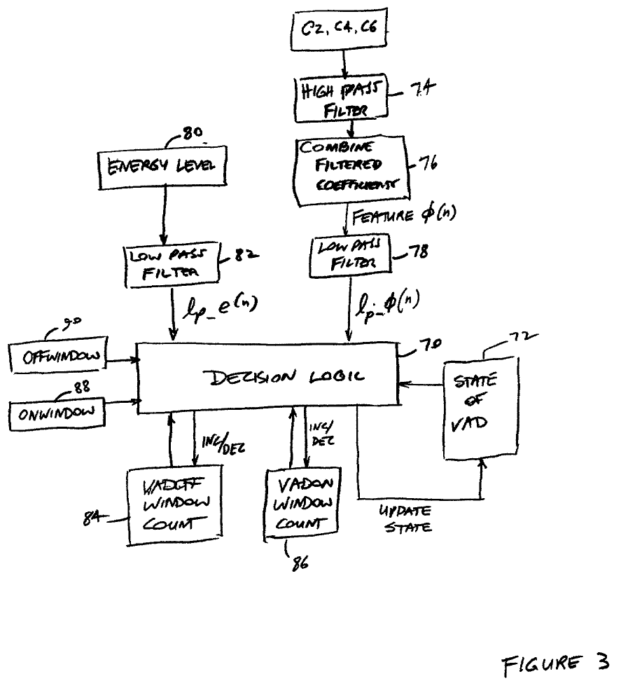

FIG. 3 is a mixed block and flow diagram.

Cepstral coefficients capture signal features that are useful for representing speech. Most speech recognition systems classify short-term speech segments into acoustic classes by applying a maximum likelihood approach to the cepstrum (the set of cepstral coefficients) of each segment/frame. The process of estimating, based on maximum likelihood, the acoustic class φ of a short-term speech segment from its cepstrum is defined as finding the minimum of the expression:

$$ϕ = min \{ {C}^{T} {Σ}^{- 1} C \}$$

where C (the cepstrum) is the vector of typically twelve cepstral coefficients c1, c2, . . . , c12, and Σ is a covariance matrix. In theory, such a classifier could be used for the simple function of discriminating speech from non-speech segments, but that function would require a substantial amount of processing time and memory resources.

To reduce the processing and memory requirements, a simpler classification system may be used to discriminate between speech and non-speech segments of a signal. The simpler system uses a function that combines only a subset of cepstral coefficients that optimally represent general properties of speech as opposed to non-speech. The optimal function of C:

ψ(t)=ℑ(C)

is capable of discriminating speech segments from non-speech segments.

One example of a useful function combines the absolute values of three particular Cepstral coefficients, c2, c4, and c6:

Ψ(t)=|c₂(t)|+|c₄(t)|+|c₆(t)|

Typically, a large absolute value for any coefficient indicates a presence of speech. In addition, the range of values of cepstral coefficients decreases with the rank of the coefficient, i.e., the higher the order (index) of a coefficient the narrower is the range of its values. Each coefficient captures a relative distribution of energy across a whole spectrum. C2 for example is proportional to the ratio of energy at low frequencies (below 2000 Hz) as compared to energy at higher frequencies (above 2000 Hz but less than 3000 Hz). Higher order coefficients indicate a presence of signal with different combinations of distributions of energies across the spectrum (see “Speech Communication Human and Machine”, Douglass O'Shaughnessy, Addison Wesley, 1990, pp 422-424, and “Fundamentals of Speech Recognition”, Lawrance Rabiner and Biing-Hwang Juang, Prentice Hall, 1993, pp 183-190). For speech/non-speech classification, the selection of C2, C4, and C6 is sufficient. This selection was derived empirically by observing each cepstral coefficient in the presence of speech and non-speech signals.

Other functions (or class of functions) may be based on other combinations of coefficients, including or not including C2, C4, or C6. The selection of C2, C4, C6 is an efficient solution. Other combinations may or may not Produce equivalent or better performance/discrimination. In some cases, adding other coefficients to C2, C4, and C6 was detrimental and/or less efficient in using more processing resources.

As explained in more detail later, whatever function is chosen is used in conjunction with a measure of energy of the signal e(t) as the basis for discrimination. Experimental results show that the combination of these three coefficients and energy provide more robust VAD while being less demanding of processor time and memory resources.

The plot of FIG. 1A depicts the signal level of an original PCM signal 50 as function of time. The signal includes portions 52 that represent speech and other portions 54 that represent non-speech. FIG. 1B depicts the energy level 56 of the signal. A threshold level 58 provides one way to discriminate between speech and non-speech segments. FIG. 1C shows the sum 60 of the absolute values of the three cepstral coefficients C2, C4, C6. Thresholds 62, 64 may be used to discriminate between speech and non-speech segments, as described later.

An example of the effectiveness of the discrimination achieved by using the selected three cepstral coefficients is illustrated by the signal segments 80, 82 (FIG. 1A) centered near 6 seconds and 11 seconds respectively. These signal segments represent a tone generated by dialing a telephone with two different energy levels. As shown in FIG. 1C, an energy threshold alone would determine the dialing tones to be speech. However, as shown in FIG. 1C, the thresholding of cepstral function T correctly determines that the dialing tones are not speech segments. Furthermore, the function T is independent of the energy level of the signal.

FIG. 2 shows an example of a signal processing system 10 that processes signals, for example, from a telephone line 13 and includes a simplified optimal voice activity detection function. An incoming pulse-code modulated (PCM) input signal 12 is received at a front end 14 where the input signal is processed using a standard Mel-cepstrum algorithm 16, such as one that is compliant with the ETSI (European Telecommunications Standards Institute) Aurora standard, Version 1.

Among other things, the front end 14 performs a fast Fourier transform (FFT) 18 on the input signal to generate a frequency spectrum 20 of the PCM signal. The spectrum is passed to a dual-tone, multiple frequency (DTMF) detector 22. If DTMF tones are detected, the signal may be handled by a back-end processor 28 with no further processing of the signal for speech purposes.

In the front end 14, the standard MEL-cepstrum coefficients are generated for each segment in a stream of segments of the incoming signal. The front end 14 derives thirteen cepstral coefficients: c₀, log energy, and c1-c12. The front end also derives the energy level 21 of the signal using an energy detector 19. The thirteen coefficients and the energy signal are provided to a VAD processor 27.

In the VAD processor, the selected three coefficients are filtered first by a high-pass filter 24 and next by a low-pass filter 26 to improve the accuracy of VAD.

The high-pass filter reduces convolutional effects introduced into the signal by the channel on which the input signal was carried. The high-pass filter may be implemented as a first-order infinite impulse response (IIR) high-pass filter with a transfer function:

$${H}_{hi} ( z ) = \frac{( 1 - a ) ( 1 - {z}^{- 1} )}{1 - {az}^{- 1}}$$

in which a=0.99, for example.

The subsequent low-pass filter provides additional robustness against short-term acoustic events such as lip-smacks or door bangs. Low-pass filtering smoothes the time trajectories of cepstral features. The transfer function of the low-pass filter is:

$${H}_{lo} ( z ) = \frac{1}{1 - {bz}^{- 1}}$$

in which b=0.8, for example.

Both filters are designed and optimized to achieve high-performance gain using minimal CPU and memory resources.

After further processing in the VAD processor, as described below, resulting VAD or end-pointing information is passed from the VAD processor to, for example, a wake-up word (on word) recognizer 30 that is part of a back end processor 28. The VAD or end-pointing information could also be sent to a large vocabulary automatic speech recognizer, not shown.

The VAD processor uses two thresholds to determine the presence or absence of speech in a segment. One threshold 44 represents an energy threshold. The other threshold 46 represents a threshold of a combination of the selected cepstral features.

As shown in FIG. 3, in an example implementation, for each segment n of the input signal, each of the cepstral coefficients c2, c4, and c6 is high-pass filtered 74 to remove DC bias:

hp_{—}cᵢ(n)=0.9*hp_{—}cᵢ(n−1)+cᵢ(n)−cᵢ(n−1)

where hp_cᵢ is the high-pass filtered value of cᵢ for i=2, 4, 6.

The high-pass filtered cepstral coefficients hp_cᵢ are combined 76, generating cepstral feature φ(n) for the nth signal segment.

φ(n)=|hp_{—}c₁(n)|+|hp_{—}c₂(n)|+|hp_{—}c₃(n)|

Finally, this feature is low-pass filtered 78, producing lp_φ(n):

lp_φ(n)=0.8*lp_φ(n−1)+0.2*φ(n)

Separately, the energy of the signal 80 is smoothed using a low-pass filter 82 implemented as follows:

lp_{—}e(n)=0.6*lp_{—}e(n−1)+0.4*e(n)

These two features, lp_φ(n) and lp_e(n) are used to decide if the nth segment (frame) of the signal is speech or non-speech as follows.

The decision logic 70 of the VAD processor maintains and updates a state of VAD 72 (VADOFF, VADON). A state of VADON indicates that the logic has determined that speech is present in the input signal. A state of VADOFF indicates that the logic has determined that no speech is present. The initial state of VAD is set to VADOFF (no speech detected). The decision logic also updates and maintains two up-down counters designed to assure that the presence or absence of speech has been determined over time. The counters are called VADOFF window count 84 and VADON window count 86. The decision logic switches state and determines that speech is present only when the VADON count gets high enough. Conversely, the logic switches state and determines that speech is not present only when the VADOFF count gets high enough.

In one implementation example, the decision logic may proceed as follows.

If the state of VAD is VADOFF (no speech present) AND if the signal feature lp_φ(n)>90 AND the signal feature lp_e(n)>7000 (together suggesting the presence of speech), then VADOffWindowCount is decremented by one to a value not less than zero, and VADOnWindowCount is incremented by one. If the counter VADOnWindowCount is greater than a threshold value called ONWINDOW 88 (which in this example is set to 5), the state is switched to VADON and the VADOnWindowCount is reset to zero.

If the state of VAD is VADON (speech present) and if the signal feature lp_φ(n)<=75 OR the signal feature lp_e(n)<=7000 (together suggesting the absence of speech), VADOnWindowCount is decremented by one to a value no less than zero, and VADOffWindowCount is incremented. If the counter VADOffWindowCount is greater than a threshold called OFFWINDOW 90 (which is set to 10 in this example), the state is switched to VADOFF; otherwise the VADOffWindowCount is reset to zero.

This logic thus causes the VAD processor to change state only when a minimum number of consecutive frames fulfill the energy and feature conditions for a transition into the new state. However, the counter is not reset if a frame does not fulfill a condition, rather the corresponding counter is decremented. This has the effect of a counter with memory and reduces the chance that short-term events not associated with a true change between speech and non-speech could trigger a VAD state change.

The front end, the VAD processor, and the back end may all be implemented in software, hardware, or a combination of software and hardware. Although the discussion above suggested that the functions of the front end, VAD processor, and back end may be performed by separate devices or software modules organized in a certain way, the functions could be performed in any combination of hardware and software. The same is true of the functions performed within each of those elements. The front end, VAD processor, and the back end could provide a wide variety of other features that cooperate with or are unrelated to those already described. The VAD is useful in systems and boxes that provide speech services simultaneously for a large number of telephone calls and in which functions must be performed on the basis of the presence or absence of speech on each of the lines. The VAD technique may be useful in a wide variety of other applications also.

Although examples of implementations have been described above, other implementations are also within the scope of the following claims. For example, the choice of cepstral coefficients could be different. More or fewer than three coefficients could be used. Other speech features could also be used. The filtering arrangement could include fewer or different elements than in the examples provided. The method of screening the effects of short-term speech events from the decision process could be different. Different threshold values could be used for the decision logic.

1. A method comprising
using a subset of values to discriminate voice activity in a signal, the subset of values belonging to a larger set of values representing a segment of a signal, the larger set of values being suitable for speech recognition.

2. The method of claim 1 in which the values comprise cepstral coefficients.

3. The method of claim 2 in which the coefficients conform to an ETSI standard.

4. The method of claim 1 in which the subset comprise three values.

5. The method of claim 3 in which the cepstral coefficients used to determine presence or absence of voice activity comprise coefficients c2, c4, and c6.

6. The method of claim 1 in which discriminating voice activity in the signal includes discriminating the presence of speech from the absence of speech.

7. The method of claim 1 applied to a sequence of segments of the signal.

8. The method of claim 1 in which the subset of values satisfies an optimality function that is capable of discriminating speech segments from non-speech segments.

9. The method of claim 8 in which the optimality function comprises a sum of absolute values of the values used to discriminate voice activity.

10. The method of claim 1 including also using a measure of energy of the speech signal to discriminate voice activity in the signal.

11. The method of claim 1 in which discriminating voice activity includes comparing an energy level of the signal with a pre-specified threshold.

12. The method of claim 1 in which discriminating voice activity includes comparing a measure of cepstral based features with a pre-specified threshold.

13. The method of claim 1 in which the discriminating for the segment is also based on values associated with other segments of the signal.

14. The method of claim 1 also including triggering a voice activity feature in response to the discrimination of voice activity in the signal.

15. A method comprising
receiving a speech signal,
deriving information about a subset of cepstral coefficients from the speech signal, and
determining the presence or absence of speech in the speech signal based on the information about the subset of cepstral coefficients.

16. The method of claim 15 in which the determining of the presence or absence of speech is also based on an energy level of the signal.

17. The method of claim 15 in which the determining of the presence or absence of speech is based on information about the cepstral coefficients derived from two or more successive segments of the signal.

18. Apparatus comprising
a port configured to receive values representing a segment of a signal, and
logic configured to use the values to discriminate voice activity in a signal, the values comprising a subset of a larger set of values representing the segment of a signal, the larger set of values being suitable for speech recognition.

19. The apparatus of claim 18 also including
a port configured to deliver as an output an indication of the presence or absence of speech in the signal.

20. The apparatus of claim 18 in which the logic is configured to tentatively determine, for each of a stream of segments of the signal, whether the presence or absence of speech has changed from its previous state, and to make a final determination whether the state has changed based on tentative determinations for more than one of the segments.

21. A medium bearing instructions configured to enable a machine to
use a subset of values to discriminate voice activity in a signal, the subset of values belonging to a larger set of values representing a segment of a signal, the larger set of values being suitable for speech recognition.
